(19) United States
(12) Patent Application Publication
(10) Pub. No.: US 2025/0254466 A1
(43) Pub. Date: Aug. 7, 2025

(54) SOUND FIELD EXPANSION METHOD, AUDIO DEVICE AND COMPUTER-READABLE STORAGE MEDIUM

(71) Applicant: GOERTEK TECHNOLOGY CO., LTD, Qingdao, Shandong (CN)

(72) Inventor: Jianhua LI, Qingdao, Shandong (CN)

(21) Appl. No.: 18/856,901

(22) PCT Filed: Sep. 28, 2023
(86) PCT No.: PCT/CN2023/122462

§ 371 Date: Oct. 15, 2024

(30) Foreign Application Priority Data
Sep. 29, 2022 (CN) 202211195319.5

(51) Int. Cl. H04R 5/04

(52) U.S. Cl. CPC H04R 5/04

(57) ABSTRACT

The disclosure discloses a sound field expansion method, an audio device and a computer readable storage medium, and belongs to a technical field of audio processing. The method comprises: acquiring a target transfer function between a near-ear open audio device and two ears of a user; performing a crosstalk elimination processing on an input audio received by the near-ear open audio device according to the target transfer function to acquire an initial reverberation audio; identifying an actual sound intensity weight ratio between a human voice audio and an accompanying audio in the initial reverberation audio; adjusting a sound intensity of the human voice audio and/or the accompanying audio in the initial reverberation audio according to the actual sound intensity weight ratio to acquire a target reverberation audio; playing the target reverberation audio. The audio device can effectively expand a sound field while ensuring a sound effect of a human voice.

This application claims a priority to a Chinese patent application No. 202211195319.5, entitled “SOUND FIELD EXPANSION METHOD, AUDIO DEVICE AND COMPUTER-READABLE STORAGE MEDIUM”, filed with the China Patent Office on Sep. 29, 2022, the entire contents of which are incorporated by reference in this application.

### TECHNICAL FIELD

The disclosure relates to a technical field of audio processing, and in particular, to a sound field expansion method, an audio device and a computer-readable storage medium.

### BACKGROUND

Sound field expansion refers to an acoustic phenomenon that a perceived sound field in hearing is wider than a position of an actual speaker. The sound field expansion is similar to a virtual speaker that can expand a sound position to a position wider than the position of the actual speaker. That is, the sound played by a sound source sounds to a human ear equivalent to an effect of the sound emitted from a virtual speaker in a wider position.

In the technical field of the audio processing, actual audio signals are mostly two-channel stereo signals. Sound field expansion technology is based on two-channel stereo, without adding channels and speakers, by performing a process on the signals, a listener feels that the sound comes from multiple directions, thus creating a simulated stereo field. At present, the sound field expansion technology (i.e. a virtual surround sound technology) has become an indispensable technology. It is mainly used in far-field sound sources, such as the situation for use of speakers. With the increasing market shipments of near-ear open audio devices such as VR and AR in recent years, the demand for the sound field expansion function of the near-ear open audio device has gradually increased.

However, the current sound field expansion function (i.e. a virtual surround sound function) is mainly implemented by a Head Related Transfer Function (HRTF) algorithm. When HRTF is adopted to expand the sound field, it often makes the human voice feel feeble. Therefore, it is particularly important to ensure the sound effect of the human voice while effectively expanding the sound field.

### SUMMARY

A main object of the present disclosure is to provide a sound field expansion method, an audio device and a computer-readable storage medium, aiming to solve a technical problem of poor sound effect of the human voice part in the audio played by the near-ear open audio device after adding the sound field expansion function.

To achieve the above object, the present disclosure provides a sound field expansion method comprising:
acquiring a target transfer function between a near-ear open audio device and two ears of a user;
performing a crosstalk elimination processing on an input audio received by the near-ear open audio device according to the target transfer function to acquire an initial reverberation audio;
identifying an actual sound intensity weight ratio between a human voice audio and an accompaniment audio in the initial reverberation audio, and adjusting a sound intensity of the human voice audio and/or the accompaniment audio in the initial reverberation audio according to the actual sound intensity weight ratio to acquire a target reverberation audio; and playing the target reverberation audio.

Optionally, the adjusting the sound intensity of the human voice audio and/or the accompaniment audio in the initial reverberation audio according to the actual sound intensity weight ratio to acquire the target reverberation audio includes:
acquiring a target sound intensity weight ratio between the human voice audio and the accompaniment audio; and
adjusting the sound intensity of the human voice audio and/or the accompaniment audio in the initial reverberation audio according to the actual sound intensity weight ratio and the target sound intensity weight ratio, such that the actual sound intensity weight ratio is adjusted to the target sound intensity weight ratio, to acquire the target reverberation audio.

Optionally, the acquiring the target sound intensity weight ratio between the human voice audio and the accompaniment audio includes:
identifying the initial reverberation audio by a converged neural network model to acquire an audio type corresponding to the initial reverberation audio; and
retrieving a sound intensity weight ratio to which the audio type maps from a preset mapping data table according to the audio type, wherein the sound intensity weight ratio to which the audio type maps is the target sound intensity weight ratio between the human voice audio and the accompaniment audio.

Optionally, the adjusting the sound intensity of the human voice audio and/or the accompaniment audio in the initial reverberation audio includes:
increasing a sound intensity of the human voice audio in the initial reverberation audio; and/or
reducing a sound intensity of the accompaniment audio in the initial reverberation audio.

Optionally, the acquiring the target transfer function between the near-ear open audio device and the ears of the user includes:
acquiring a preset artificial head transfer function and a free-field transfer function;
performing an inverse operation on the free-field transfer function to acquire a free-field inverse transfer function; and
multiplying the artificial head transfer function by the free-field inverse transfer function, to acquire the target transfer function between the near-ear open audio device and the ears of the user.

Optionally, the acquiring the preset artificial head transfer function and the free-field transfer function includes:
when the near-ear open audio device is worn on a preset artificial head and the near-ear open audio device outputs a sound signal, measuring the artificial head transfer function by preset microphones in ear canals of the artificial head; and
when the artificial head is removed and the near-ear open audio device outputs a sound signal, measuring a free-field transfer function by preset microphones placed at positions of left and right ears s before the artificial head is removed.

Optionally, the performing the crosstalk elimination processing on the input audio received by the near-ear open audio device according to the target transfer function to acquire the initial reverberation audio includes:
performing an inverse operation on the target transfer function to acquire a target inverse transfer function; and
multiplying the input audio received by the near-ear open audio device by the target inverse transfer function to acquire the initial reverberation audio.

Optionally, the identifying the actual sound intensity weight ratio between the human voice audio and the accompaniment audio in the initial reverberation audio includes:
dividing the initial reverberation audio into a plurality of frames, wherein each frame of the initial reverberation audio has an accompaniment audio and a human voice audio in a time-synchronized relationship;
performing a windowing processing on each frame of the initial reverberation audio, and transforming the initial reverberation audio after the windowing processing from a time domain to a frequency domain by a fast Fourier transform, to acquire an initial reverberation spectrum;
separating the initial reverberation spectrum to acquire an accompaniment spectrum and a human voice spectrum in the initial reverberation spectrum; and
determining the actual sound intensity weight ratio between the human voice audio and the accompaniment audio in the initial reverberation spectrum according to the accompaniment spectrum and the human voice spectrum,
wherein the adjusting the sound intensity of the human voice audio and/or the accompaniment audio in the initial reverberation audio according to the actual sound intensity weight ratio and the target sound intensity weight ratio to acquire the target reverberation audio includes:
performing a sound intensity increasing process on the human voice spectrum in the initial reverberation spectrum and/or performing a sound intensity decreasing process on the accompaniment spectrum in the initial reverberation audio according to the actual sound intensity weight ratio and the target sound intensity weight ratio, to acquire a target reverberation spectrum; and
transforming the target reverberation spectrum from the frequency domain to the time domain to acquire the target reverberation audio.

In addition, to achieve the above object, the present application further provides an audio device which includes: a memory, a processor, and a sound field expansion program stored in the memory and executable by the processor, wherein the sound field expansion program, when executed by the processor, implements steps of the sound field expansion method as described above.

In addition, to achieve the above object, the present application further provides a computer-readable storage medium, wherein a sound field expansion program is stored on the computer-readable storage medium, and when the sound field expansion program is executed by a processor, steps of the sound field expansion method as described above are implemented.

In the present disclosure, the target transfer function between the near-ear open audio device and the two ears of the user is acquired, and then the crosstalk elimination processing is performed on the input audio received by the near-ear open audio device according to the target transfer function to acquire the initial reverberation audio, so that the ears of the user wearing the near-ear open audio device receive a sound signal consistent with the input audio, and eliminates the interference of the near-ear open audio device itself with the sound signal. In the case that the speaker of the near-ear open audio device cannot be placed in the human ear like the earphones, the listening effect of the sound played by the near-ear open audio device when it is transmitted to the two ears of the user is consistent with the listening effect when the earphones are worn, which effectively improving the hearing sense of the user group of the near-ear open audio device and avoiding the crosstalk problem. However, since the current sound field expansion function is mainly implemented by a Head Related Transfer Function (HRTF) algorithm, when the HRTF is adopted to expand the sound field, it often makes the human voice feel feeble. That is, the initial reverberation audio acquired after the sound field expansion often has a smaller actual sound intensity weight ratio between the human voice audio and the accompaniment audio, that is, the weight of the sound intensity of the human voice audio in the initial reverberation audio is often smaller, while the weight of the sound intensity of the accompaniment audio in the initial reverberation audio is often larger. Therefore, in the present disclosure, the actual sound intensity weight ratio between the human voice audio and the accompaniment audio in the initial reverberation audio is dynamically identified, and it is determined whether the actual sound intensity weight ratio is within a preset standard sound intensity weight ratio range. If the actual sound intensity weight ratio exceeds the preset standard sound intensity weight ratio range, it means that the audio currently played by the near-ear open audio device when the HRTF sound field expansion is performed has the problem of feeble human voice. Therefore, in the present disclosure, the sound intensity of the human voice audio and/or the accompaniment audio in the initial reverberation audio is adjusted, the weight of the sound intensity of the human voice audio in the initial reverberation audio is increased, the target reverberation audio is acquired and played, thereby improving the problem of feeble human voice caused by the near-ear open audio device when the sound field expansion is performed by HRTF. That is, in the present disclosure, the accompaniment audio signal and the human voice signal of the song to be processed are extracted, and then the sound intensity of the accompaniment audio signal and/or the human voice signal of the initial reverberation audio is adjusted according to reverberation degree values of the extracted accompaniment audio signal and the human voice signal, thereby achieving the technical effect of ensuring the sound effect of the human voice while effectively expanding the sound field, and overcoming the technical problem of poor sound effect of the human voice part in the audio played by the near-ear open audio device after adding the sound field expansion function.

### BRIEF DESCRIPTION OF DRAWINGS

FIG. 1 is a flow chart of a first embodiment of a sound field expansion method of the present disclosure;

FIG. 2 is a flow chart of a second embodiment of a sound field expansion method of the present disclosure;

FIG. 3 is a schematic diagram of an application scenario of an embodiment of a sound field expansion method of the present disclosure;

FIG. 4 is a flow chart for identifying the actual sound intensity weight ratio between human voice audio and accompaniment audio in an embodiment of the present disclosure; and

FIG. 5 is a schematic diagram of a structure of an audio device involved in an embodiment of the present disclosure.

The realization of the purpose, functional features and advantages of the present disclosure will be further explained in conjunction with embodiments and with reference to the accompanying drawings.

### DETAILED DESCRIPTIONS

It should be understood that the specific embodiments described herein are only used to explain the present application and are not used to limit the present application.

A main solution of the embodiment of the present application is a sound field expansion method comprising:
acquiring a target transfer function between a near-ear open audio device and two ears of a user;
performing a crosstalk elimination processing on an input audio received by the near-ear open audio device according to the target transfer function to acquire an initial reverberation audio;
identifying an actual sound intensity weight ratio between a human voice audio and an accompaniment audio in the initial reverberation audio, and adjusting a sound intensity of the human voice audio and/or the accompaniment audio in the initial reverberation audio according to the actual sound intensity weight ratio to acquire a target reverberation audio; and playing the target reverberation audio.

Since the sound field expansion technology (i.e. the virtual surround sound technology) has become an indispensable technology, it is mainly used in far-field sound sources, such as the situation for use of speakers. With the increasing market shipments of near-ear open audio devices such as VR and AR in recent years, the demand for the sound field expansion function of the near-ear open audio device has gradually increased. However, the current sound field expansion function (i.e. the virtual surround sound function) is mainly implemented by the Head Related Transfer Function (HRTF) algorithm. When HRTF is adopted to expand the sound field, it often makes the human voice feeble.

In the present disclosure, the actual sound intensity weight ratio between the human voice audio and the accompaniment audio in the initial reverberation audio is dynamically identified, and it is determined whether the actual sound intensity weight ratio is within a preset standard sound intensity weight ratio range. If the actual sound intensity weight ratio exceeds the preset standard sound intensity weight ratio range, it means that the audio currently played by the near-ear open audio device when the HRTF sound field expansion is performed has the problem of feeble human voice. Therefore, in the present disclosure, the sound intensity of the human voice audio and/or the accompaniment audio in the initial reverberation audio is adjusted, the weight of the sound intensity of the human voice audio in the initial reverberation audio is increased, the target reverberation audio is acquired and played, thereby improving the problem of feeble human voice caused by the near-ear open audio device when the sound field expansion is performed by HRTF. That is, in the present disclosure, the accompaniment audio signal and the human voice signal of the song to be processed are extracted, and then the sound intensity of the accompaniment audio signal and/or the human voice signal of the initial reverberation audio is adjusted according to the reverberation degree values of the extracted accompaniment audio signal and the human voice signal, thereby achieving the technical effect of ensuring the sound effect of the human voice while effectively expanding the sound field, and overcoming the technical problem of poor sound effect of the human voice part in the audio played by the near-ear open audio device after adding the sound field expansion function.

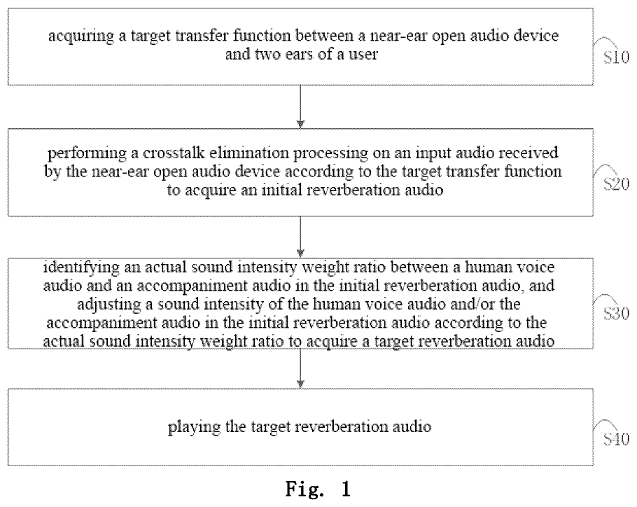

An embodiment of the present application provides a sound field expansion method. Referring to FIG. 1, FIG. 1 is a flow chart of an embodiment of the sound field expansion method of the present application.

In this embodiment, the sound field expansion method includes:
Step S10, acquiring a target transfer function between the near-ear open audio device and the two ears of a user;
In this embodiment, the execution subject is the near-ear open audio device, which includes but is not limited to Augmented Reality (AR), Virtual Reality (VR), smart audio glasses, neck-hanging speakers, open earphones and other products. Compared with the speaker scenario, the position of the speaker or the loudspeaker of the near-ear open audio device is closer to the human ear, and the near-ear open device is generally an all-in-one machine, and the distance between its playback device and the human ear is almost unadjustable, that is, in general, the sound played by the near-ear open audio device heard by the human ear is a near-field sound effect. It can be understood in conjunction with FIG. 3, which is a schematic diagram of an application scenario provided by this embodiment. Assuming that the relative position of the head position of the user and the device speaker is as shown in FIG. 3, it is obvious that when the user uses the near-ear open audio device, the user will be affected by the environment and the crosstalk problem may be caused. For example, there are the influence of the transfer function of the near-ear open audio device itself on the result and the influence of the sound signal entering the ear canal through the head contour on the result of the user, which result in the hearing experience not being able to achieve the best effect, so it is necessary to improve the hearing experience of the user by acquiring the target transfer function between the near-ear open audio device and the two ears of the user.

In this embodiment, the target transfer function between the near-ear open audio device and the two ears of the user, that is, the transfer function from the output sound source (i.e., the speaker or the loudspeaker) of the near-ear open audio device to the two ears of the user, is used to reflect the changes in the input audio of the near-ear open audio device during the process of transmitting the input audio to the two ears of the user.

Based on this, in a feasible embodiment, the above step S10 may include:
Step S11, acquiring a preset artificial head transfer function and a free-field transfer function;
It should be noted that, in this embodiment, the above-mentioned target transfer function can be understood as the influence of the head contour of the user on the sound signal transmission result, and the target transfer function cannot be directly acquired, but is acquired by calculation after acquiring two different acoustic transfer functions based on two different sound transmission scenarios. Among them, the artificial head transfer function is an acoustic transfer function measured by preset microphones in the ear canals of the artificial head when the near-ear open audio device is worn on the preset artificial head and the near-ear open audio device outputs a sound signal, which includes the influence of the playback device and the human head contour on the sound transmission result; the free-field transfer function is an acoustic transfer function measured by preset microphones placed at positions of the left and right ears before the artificial head is removed when the artificial head is removed and the near-ear open audio device outputs the sound signal, which includes the influence of the playback device on the sound transmission result.

It is easy to understand that when the current near-ear open audio devices are performing expanding of the sound field, the mentioned various transfer functions (such as the artificial head transfer function and the free-field transfer function) are all head-related transfer functions.

Furthermore, in a feasible embodiment, the step of acquiring the artificial head transfer function in the above step S11 may include:
Step S111, when the near-ear open audio device is worn on a preset artificial head and the near-ear open audio device outputs a sound signal, measuring an artificial head transfer function through preset microphones in the ear canals of the artificial head; and
It should be noted that the preset artificial head is an auxiliary device constructed to simulate the head of the user for assisting in measuring the acoustic transfer function. It can simulate the scenario in which the user receives sound signals emitted from the speakers of the near-ear open audio device. The preset artificial head is provided with left and right ears and ear canals, and microphones for receiving the sound signals can be pre-placed in the ear canals.

As an example, combined with the application scenario shown in FIG. 3, it can be seen that the near-ear open audio device is worn on the artificial head, and the two preset microphones in the ear canals of the artificial head are used to measure the acoustic transfer function from the sound source (i.e., the speaker or the loudspeaker of the near-ear open audio device) to the two ears of the artificial head, and it is recorded as H1.
Step S112, when the artificial head is removed and the near-ear open audio device outputs a sound signal, a free-field transfer function is measured by preset microphones placed at the positions of the left and right ears before the artificial head is removed.

As an example, combined with the application scenario shown in FIG. 3, it can be seen that two microphones consistent with those in the ear canals of the artificial head in the above step S111 are placed at the positions of the left and right ears of the artificial head, and then the artificial head is removed, and the acoustic transfer function of the sound source when operating in the free-field is measured using two microphones that are not affected by the artificial head, and is recorded as H2.

After the step S11, a step S12 is performed: performing an inverse operation on the free-field transfer function to acquire a free-field inverse transfer function; and
Step S13: multiplying the artificial head transfer function by the free-field inverse transfer function, to acquire a target transfer function between the near-ear open audio device and the two ears of the user.

In this embodiment, the free-field transfer function H2 acquired in the above step S112, which includes the influence of the playback device on the sound transfer result, is first inverted to acquire a free-field inverse transfer function, which is recorded as H2′, and then the artificial head transfer function H1 acquired in the above step S111, which includes the influence of the playback device and the human head contour on the sound transfer result, is multiplied by H2′ to acquire the target transfer function H. It should be noted that H2′ acquired after the inversion operation can eliminate the influence of the playback device on the sound transfer result, and after multiplying it with H1, the part of H1 that is influenced by the playback device on the sound transfer result can be eliminated, and the influence of the human head contour on the sound transfer result is retained as the target transfer function H.
Step S20, performing a crosstalk elimination processing on an input audio received by the near-ear open audio device according to the target transfer function to acquire an initial reverberation audio;
It can be understood that since the speakers or the loudspeakers of the near-ear open audio devices are not ideal sound sources, and the speakers or the loudspeakers of the near-ear open audio devices cannot be directly placed in the binaural ear canals of the user as the playback devices, crosstalk problems will inevitably occur during the transmission of the initial reverberation audio. In order to avoid this problem, the input audio is first subjected to the crosstalk elimination processing before the initial reverberation audio is generated, that is, the crosstalk problem that occurs during the transmission of the initial reverberation audio after playback is canceled. That is, the initial reverberation audio is acquired after the input audio is subjected to the crosstalk elimination processing, which can offset the influence of the playback device itself during the sound transmission process and the influence of the head of the user on the sound signal.

As an example, the above step S20 may include:
Step S21, performing an inverse operation on the target transfer function to acquire a target inverse transfer function; and
Step S22: multiplying the input audio received by the near-ear open audio device by the target inverse transfer function to acquire the initial reverberation audio.

From the above steps, it can be known that the target transfer function H represents the influence of the human head contour on the sound transfer result. It should be understood that the target inverse transfer function acquired after inverting H is equivalent to a unit matrix, which represents the elimination of the influence of the human head contour on the sound transfer result. The initial reverberation audio acquired after applying it to the input audio for processing can obviously cancel the influence of the human head contour on the sound transfer result when the sound signal is transmitted, so that the audio received by the two ears of the user can be consistent with the input audio.

As an example, combined with the application scenario shown in FIG. 3, it can be seen that when the input audio X of the near-ear open audio device is given, the input audio X is processed by the crosstalk elimination algorithm module and then output by SPK (speaker), and the output signal is transmitted to the human ears through the human head model. Among them, the basic idea of implementing the crosstalk elimination algorithm module is to first acquire the transfer function H of the sound to the human ears after the SPK generates sounds, and then invert the transfer function by the crosstalk elimination algorithm module. The both work together to achieve the effect of reducing and eliminating the crosstalk. If the inverse of H is recorded as C, the initial reverberation audio Y=XCH is the audio signal after the crosstalk is eliminated.
Step S30, identifying an actual sound intensity weight ratio between a human voice audio and an accompaniment audio in the initial reverberation audio, and adjusting a sound intensity of the human voice audio and/or the accompaniment audio in the initial reverberation audio according to the actual sound intensity weight ratio to acquire a target reverberation audio;
In the present embodiment, the actual sound intensity weight ratio refers to the weight ratio of the sound intensity of the human voice audio to the sound intensity of the accompaniment audio in the initial reverberation audio. It is easy to understand that the sound intensity, also known as a volume or a loudness, refers to a strength of a sound felt by the human ears, and is a subjective feeling of the sound magnitude. In other words, the sound intensity is a degree of a loudness of the sound. It should be noted that since the current sound field expansion function (i.e., a virtual surround sound function) is mainly implemented by the Head Related Transfer Function (HRTF) algorithm, when the HRTF is adopted to expand the sound field, it often makes the human voice feel feeble. That is, the initial reverberation audio acquired after the sound field expansion often has a smaller actual sound intensity weight ratio between the human voice audio and the accompaniment audio, that is, the weight of the sound intensity of the human voice audio in the initial reverberation audio is often smaller, while the weight of the sound intensity of the accompaniment audio in the initial reverberation audio is often larger. Therefore, in this embodiment, the actual sound intensity weight ratio between the human voice audio and the accompaniment audio in the initial reverberation audio is dynamically identified by the human voice identification module and the accompaniment sound identification module (as shown in FIG. 3), and it is determined whether the actual sound intensity weight ratio is within the preset standard sound intensity weight ratio range. If the actual sound intensity weight ratio exceeds the preset standard sound intensity weight ratio range, it means that the audio currently played by the near-ear open audio device when the HRTF sound field expansion is performed has the problem of human voice becoming feeble. Therefore, in this embodiment, the sound intensity of the human voice audio and/or the accompaniment audio in the initial reverberation audio is adjusted, and the weight of the sound intensity of the human voice audio in the initial reverberation audio is increased, thereby improving the problem of feeble human voice caused by the near-ear open audio device when the sound field expansion is performed by HRTF.

As an example, the step of adjusting the sound intensity of the human voice audio and/or the accompaniment audio in the initial reverberation audio includes:
Step S321, increasing a sound intensity of the human voice audio in the initial reverberation audio; and/or
Step S322: reducing a sound intensity of the accompaniment audio in the initial reverberation audio.

After step S30, step S40 is performed: playing the target reverberation audio.

In this embodiment, the target transfer function between the near-ear open audio device and the two ears of the user is acquired, and then the crosstalk elimination processing is performed on the input audio received by the near-ear open audio device according to the target transfer function to acquire the initial reverberation audio, so that the ears of the user wearing the near-ear open audio device receive the sound signal consistent with the input audio. In this embodiment, the head-related transfer function in different scenarios is calculated by the sound source simulation, which can eliminate the interference of the near-ear open audio device itself on the sound signal, so that when the speaker of the near-ear open audio device cannot be placed in the human ears like the earphones, the listening effect of the sound played by the near-ear open audio device when it is transmitted to the two ears of the user is consistent with the listening effect when the earphone are worn, which effectively improving the hearing sense of the user group of the near-ear open audio device and avoiding the crosstalk problem. However, since the current sound field expansion function is mainly implemented by the head-related transfer function (HRTF) algorithm, when the HRTF is adopted to expand the sound field, it often makes the human voice feel feeble. That is, the initial reverberation audio acquired after the sound field expansion often has a smaller actual sound intensity weight ratio between the human voice audio and the accompaniment audio, that is, the weight of the sound intensity of the human voice audio in the initial reverberation audio is often smaller, while the weight of the sound intensity of the accompaniment audio in the initial reverberation audio is often larger. Therefore, in this embodiment, the actual sound intensity weight ratio between the human voice audio and the accompaniment audio in the initial reverberation audio is dynamically identified, and it is determined whether the actual sound intensity weight ratio is within a preset standard sound intensity weight ratio range. If the actual sound intensity weight ratio exceeds the preset standard sound intensity weight ratio range, it means that the audio currently played by the near-ear open audio device when the HRTF sound field expansion is performed has the problem of feeble human voice. Therefore, in this embodiment, the sound intensity of the human voice audio and/or the accompaniment audio in the initial reverberation audio is adjusted, the weight of the sound intensity of the human voice audio in the initial reverberation audio is increased, the target reverberation audio is acquired and played, thereby improving the problem of feeble human voice caused by the near-ear open audio device when the sound field expansion is performed by HRTF. That is, since the head transfer function is acquired based on the near field/far field/free-field and the sound field crosstalk elimination processing is performed by the head transfer function, the problem of a feeble human voice will arise. In the present embodiment, the accompaniment audio signal and the human voice signal of the song to be processed are extracted, and then the sound intensity of the accompaniment audio signal and/or the human voice signal of the initial reverberation audio is adjusted according to the reverberation degree values of the extracted accompaniment audio signal and the human voice signal, thereby achieving the technical effect of effectively expanding the sound field while ensuring the sound effect of the human voice, and overcoming the technical problem of poor sound effect of the human voice part in the audio played by the near-ear open audio device after adding the sound field expansion function.

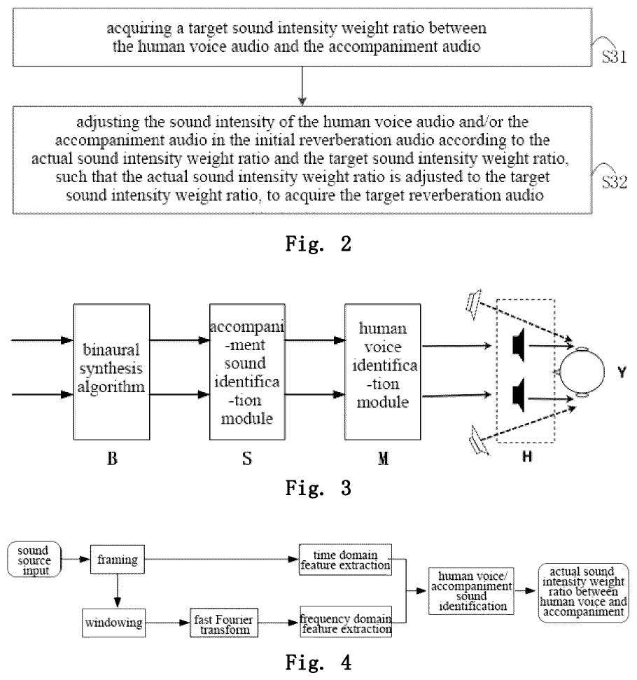

In a possible implementation, referring to FIG. 2, the step of adjusting the sound intensity of the human voice audio and/or the accompaniment audio in the initial reverberation audio according to the actual intensity weight ratio to acquire the target reverberation audio includes:
Step S31, acquiring the target sound intensity weight ratio between the human voice audio and the accompaniment audio;
In one embodiment, the target sound intensity weight ratio may be acquired by experimental calibration before leaving the factory and pre-stored in the system of the near-ear open audio device. The near-ear open audio device with the sound field expansion function added may acquire the target sound intensity weight ratio from the system before leaving the factory. In another embodiment, the target sound intensity weight ratio may also be acquired after leaving the factory by the user inputting the target sound intensity weight ratio into the system of the near-ear open audio device based on the personal listening comfort experience and habits of the user for the audio. In further another embodiment, the near-ear open audio device may acquire the theoretical sound intensity weight ratio corresponding to the same reverberation audio (i.e., the same audio as the initial reverberation audio, except that the sound field expansion processing is not performed) output by the near-ear open audio device when the sound field expansion function is not turned on, and the theoretical sound intensity weight ratio is used as the target sound intensity weight ratio.
Step S32: adjusting the sound intensity of the human voice audio and/or the accompaniment audio in the initial reverberation audio according to the actual sound intensity weight ratio and the target sound intensity weight ratio, such that the actual sound intensity weight ratio is adjusted to the target sound intensity weight ratio, to acquire the target reverberation audio.

In this embodiment, the target sound intensity weight ratio between the human voice audio and the accompaniment audio is acquired, and the sound intensity of the human voice audio and/or the accompaniment audio in the initial reverberation audio is acquired according to the actual sound intensity weight ratio and the target sound intensity weight ratio, such that the actual sound intensity weight ratio is adjusted to the target sound intensity weight ratio, thereby more accurately adjusting the sound intensity of the accompaniment audio signal and/or the human voice signal of the initial reverberation audio, thereby achieving the technical effect of effectively expanding the sound field while ensuring the sound effect of the human voice.

As an example, the step S31, the step of the acquiring the target sound intensity weight ratio between the human voice audio and the accompaniment audio includes:
Step S311, identifying the initial reverberation audio by a converged neural network model to acquire an audio type corresponding to the initial reverberation audio; and
Step S312: retrieving a sound intensity weight ratio to which the audio type maps from the preset mapping data table according to the audio type, wherein the sound intensity weight ratio to which the audio type maps is the target sound intensity weight ratio between the human voice audio and the accompaniment audio.

In this embodiment, it can be understood by those skilled in the art that different audio types correspondingly need to achieve different standard sound intensity weight ratios to achieve a better sound intensity ratio between the accompaniment and the human voice, to enhance the listening comfort experience of the user. For example, the sound intensity ratio of the human voice in folk songs is often relatively higher, that is, the weight of the sound intensity of the human voice audio in the folk songs is relatively large. However, an ancient music often requires the sound intensity of the accompaniment to be relatively higher, that is, the weight of the sound intensity of the accompaniment audio in the ancient music is relatively larger. For example, a rock music requires a relatively moderate sound intensity ratio between the accompaniment and the human voice (close to 1:1). In this embodiment, the neural network model can be trained by pre-training audio samples of different audio types (such as the rock music, the folk songs, the ancient music, folk music, rap, etc.), and the prediction accuracy of the neural network model for the audio type can be manually verified. If the prediction accuracy of the audio sample for a preset number of consecutive audio samples reaches a preset threshold (for example, 95%), it is determined that the neural network model converges, and a converged neural network model is acquired.

In this embodiment, the initial reverberation audio is identified by the convergent neural network model to acquire the audio type corresponding to the initial reverberation audio, and according to the audio type, the sound intensity weight ratio to which the audio type maps is retrieved from the preset mapping data table, and the sound intensity weight ratio to which the audio type maps is used as the target sound intensity weight ratio between the human voice audio and the accompaniment audio, thereby improving the intelligence and accuracy of identifying the target sound intensity weight ratio of the initial reverberation audio.

Furthermore, in the step S30, the step of identifying the actual sound intensity weight ratio between the human voice audio and the accompaniment audio in the initial reverberation audio includes:
Step S51, dividing the initial reverberation audio into a plurality of frames, wherein each frame of the initial reverberation audio has an accompaniment audio and a human voice audio in a time-synchronized relationship;
In this embodiment, each frame of the initial reverberation audio after framing may include a preset number of sound sampling points, and there are a preset number of overlapping sampling points between adjacent frames. For example, in this embodiment, the time domain signal of the initial reverberation audio may be divided into N frames, each frame includes 512 sound sampling points (the audio sampling rate is 16 khz), and there are 256 overlapping sampling points between adjacent frames. The purpose of this processing is to achieve a smooth transition effect between frames.
Step S52, performing a windowing processing on each frame of the initial reverberation audio, and transforming the initial reverberation audio after the windowing processing from the time domain to a frequency domain by a fast Fourier transform, to acquire an initial reverberation spectrum;
In this embodiment, the fast Fourier transform (FFT) is a general term for an efficient and fast calculation method for calculating discrete Fourier transform (DFT) using a computer. The initial reverberation audio after windowing can be converted from the time domain to the frequency domain by the fast Fourier transform method, to acquire the amplitude and phase information of each frame of the initial reverberation audio, that is, the initial reverberation spectrum.
Step S53, separating the initial reverberation spectrum to acquire an accompaniment spectrum and a human voice spectrum in the initial reverberation spectrum; and
Step S54, determining the actual sound intensity weight ratio between the human voice audio and the accompaniment audio in the initial reverberation spectrum according to the accompaniment spectrum and the human voice spectrum,

In the step S32, the step of adjusting the sound intensity of the human voice audio and/or the accompaniment audio in the initial reverberation audio according to the actual intensity weight ratio and the target intensity weight ratio to acquire the target reverberation audio includes:
Step S55, performing a sound intensity increasing process on the human voice spectrum in the initial reverberation spectrum and/or performing a sound intensity decreasing process on the accompaniment spectrum in the initial reverberation audio according to the actual sound intensity weight ratio and the target sound intensity weight ratio, to acquire a target reverberation spectrum; and
Step S56: transforming the target reverberation spectrum from the frequency domain to the time domain to acquire the target reverberation audio.

In this embodiment, the target reverberation spectrum may be converted from the frequency domain to the time domain by inverse Fourier transform to acquire the target reverberation audio.

The logic of the human voice/accompaniment sound identification algorithm is shown in FIG. 4. It should be noted that in the process of extracting the human voice/accompaniment sound features, the used features include but are not limited to: Spectral Entropy, Linear Prediction Cepstrum Coefficients (LPCC) and Line Spectrum Pair (LSP), short-time energy, Mel-scale Frequency Cepstral Coefficients (MFCC), first-order difference Mel-scale cepstrum coefficients (first-order difference MFCC), loudness and glottal excitation pulse, etc.

In this embodiment, referring to FIG. 4, in this embodiment, frame division, windowing, and fast Fourier transform processing is performed on the initial reverberation audio, the initial reverberation audio is converted from the time domain to the frequency domain, an initial reverberation spectrum is acquired, and the frequency domain features of the initial reverberation spectrum is analyzed, thereby extracting the accompaniment spectrum and the human voice spectrum, and determining the actual sound intensity weight ratio between the human voice audio and the accompaniment audio according to the extracted accompaniment spectrum and the human voice spectrum, thereby accurately and effectively analyzing the actual sound intensity weight ratio of the initial reverberation audio, and then, performing sound intensity increase processing on the human voice spectrum in the initial reverberation spectrum and/or performing sound intensity reduction processing on the accompaniment spectrum in the initial reverberation audio according to the actual sound intensity weight ratio and the target sound intensity weight ratio, to acquire a target reverberation spectrum, and finally transforming the target reverberation spectrum from the frequency domain to the time domain to acquire the target reverberation audio, thereby more accurately adjusting the sound intensity of the accompaniment audio signal and/or the human voice signal of the initial reverberation audio, to achieve the goal of effectively expanding the sound field while ensuring the sound effect of the human voice.

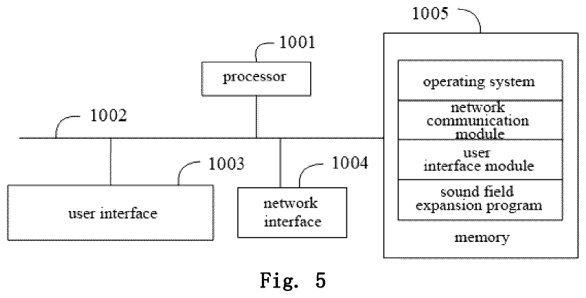

In addition, the embodiment of the present application also proposes an audio device. Referring to FIG. 5, FIG. 5 is a schematic diagram of the structure of the audio device involved in the embodiment of the present application.

As shown in FIG. 5, the audio device may include: a processor 1001, a communication bus 1002, a user interface 1003, a network interface 1004, and a memory 1005. Among them, the processor 1001 may be a central processing unit (CPU). The communication bus 1002 is used to realize the connection and communication between these components. The user interface 1003 may include a display screen (Display), an input unit such as a keyboard (Keyboard), and the optional user interface 1003 may also include a standard wired interface and a standard wireless interface. The network interface 1004 may optionally include a standard wired interface and a standard wireless interface (such as a wireless fidelity (WI-FI) interface). The memory 1005 may be a high-speed random access memory (RAM) memory, or a stable non-volatile memory (NVM), such as a disk memory. The memory 1005 may also be a storage device independent of the aforementioned processor 1001.

Those skilled in the art will appreciate that the structure shown in FIG. 5 does not constitute a limitation on the audio device, and may include more or fewer components than shown in the drawings, or a combination of certain components, or a different arrangement of components.

As shown in FIG. 5, the memory 1005 as a storage medium may include an operating system, a data storage module, a network communication module, a user interface module, and a sound field expansion program.

In the audio device shown in FIG. 5, the network interface 1004 is mainly used for data communication with other devices; the user interface 1003 is mainly used for data interaction with the user; the processor 1001 and the memory 1005 in this embodiment may be disposed in the audio device, and the audio device calls the sound field expansion program stored in the memory 1005 by the processor 1001, and performs the following operations:
acquiring a target transfer function between the near-ear open audio device and the two ears of the user;
performing the crosstalk elimination processing on the input audio received by the near-ear open audio device according to the target transfer function to acquire the initial reverberation audio;
identifying an actual sound intensity weight ratio between the human voice audio and the accompaniment audio in the initial reverberation audio, and adjusting the sound intensity of the human voice audio and/or the accompaniment audio in the initial reverberation audio according to the actual sound intensity weight ratio to acquire a target reverberation audio; and
playing the target reverberation audio.

Optionally, the processor 1001 may call the sound field expansion program stored in the memory 1005, and further perform the following operations:
acquiring a target sound intensity weight ratio between the human voice audio and the accompaniment audio; and
adjusting the sound intensity of the human voice audio and/or the accompaniment audio in the initial reverberation audio according to the actual sound intensity weight ratio and the target sound intensity weight ratio, such that the actual sound intensity weight ratio is adjusted to the target sound intensity weight ratio, to acquire the target reverberation audio.

Optionally, the processor 1001 may call the sound field expansion program stored in the memory 1005, and further perform the following operations:
identifying the initial reverberation audio by a converged neural network model to acquire an audio type corresponding to the initial reverberation audio; and
retrieving the sound intensity weight ratio to which the audio type maps from the preset mapping data table according to the audio type, wherein the sound intensity weight ratio to which the audio type maps is the target sound intensity weight ratio between the human voice audio and the accompaniment audio.

Optionally, the processor 1001 may call the sound field expansion program stored in the memory 1005, and further perform the following operations:
increasing the sound intensity of the human voice audio in the initial reverberation audio; and/or
reducing the sound intensity of the accompaniment audio in the initial reverberation audio.

Optionally, the processor 1001 may call the sound field expansion program stored in the memory 1005, and further perform the following operations:
acquiring a preset artificial head transfer function and a free-field transfer function;
performing an inverse operation on the free-field transfer function to acquire a free-field inverse transfer function; and
multiplying the artificial head transfer function by the free-field inverse transfer function, to acquire a target transfer function between the near-ear open audio device and the ears of the user.

Optionally, the processor 1001 may call the sound field expansion program stored in the memory 1005, and further perform the following operations:
when the near-ear open audio device is worn on a preset artificial head and the near-ear open audio device outputs a sound signal, measuring the artificial head transfer function by preset microphones in the ear canals of the artificial head; and
when the artificial head is removed and the near-ear open audio device outputs a sound signal, measuring a free-field transfer function by preset microphones placed at positions of the left and right ears before the artificial head is removed.

Optionally, the processor 1001 may call the sound field expansion program stored in the memory 1005, and further perform the following operations:
performing an inverse operation on the target transfer function to acquire a target inverse transfer function; and
multiplying the input audio received by the near-ear open audio device by the target inverse transfer function to acquire initial reverberation audio.

Optionally, the processor 1001 may call the sound field expansion program stored in the memory 1005, and further perform the following operations:
separating the initial reverberation spectrum to acquire an accompaniment spectrum and a human voice spectrum in the initial reverberation spectrum;
determining an actual sound intensity weight ratio between the human voice audio and the accompaniment audio in the initial reverberation spectrum according to the accompaniment spectrum and the human voice spectrum;
The step of adjusting the sound intensity of the human voice audio and/or the accompaniment audio in the initial reverberation audio according to the actual sound intensity weight ratio and the target sound intensity weight ratio to acquire the target reverberation audio includes:
performing a sound intensity increasing process on the human voice spectrum in the initial reverberation spectrum and/or performing a sound intensity decreasing process on the accompaniment spectrum in the initial reverberation audio according to the actual sound intensity weight ratio and the target sound intensity weight ratio, to acquire a target reverberation spectrum; and
transforming the target reverberation spectrum from the frequency domain to the time domain to acquire the target reverberation audio.

In addition, an embodiment of the present application also proposes a computer-readable storage medium, which is applied to a computer. The computer-readable storage medium can be a non-volatile computer-readable storage medium. A sound field expansion program is stored on the computer-readable storage medium. When the sound field expansion program is executed by a processor, the steps of the sound field expansion method of the present application as described above are implemented.

The various embodiments of the audio device and the computer-readable storage medium of the present application may refer to the various embodiments of the sound field expansion method of the present application, which will not be described in detail here.

It should be noted that, herein, the terms “include”, “comprise” or any other variations thereof are intended to cover non-exclusive inclusion, so that a process, method, article or system including a series of elements includes not only those elements, but also other elements not explicitly listed, or also includes elements inherent to such process, method, article or system. In the absence of further restrictions, an element defined by the sentence “comprises a . . . ” does not exclude the existence of other identical elements in the process, method, article or system including the element.

The serial numbers of the above-mentioned embodiments of the present application are for description only and do not represent the advantages or disadvantages of the embodiments.

Through the description of the above implementation methods, those skilled in the art can clearly understand that the above-mentioned embodiment methods can be implemented by means of software plus a necessary general hardware platform, and of course by hardware, but in many cases the former is a better implementation method. Based on such an understanding, the technical solution of the present application is essentially or the part that contributes to the prior art can be embodied in the form of a software product, which is stored in a storage medium (such as ROM/RAM, magnetic disk, optical disk) as described above, and includes a number of instructions for a terminal device (which can be a mobile phone, computer, server, air conditioner, or network device, etc.) to execute the methods described in each embodiment of the present application.

The above are only preferred embodiments of the present application, and are not intended to limit the patent scope of the present application. Any equivalent structure or equivalent process transformation made using the contents of the present application specification and drawings, or directly or indirectly applied in other related technical fields, are also included in the patent protection scope of the present application.

1. A sound field expansion method comprising:
acquiring a target transfer function between a near-ear open audio device and two ears of a user;
performing a crosstalk elimination processing on an input audio received by the near-ear open audio device according to the target transfer function to acquire an initial reverberation audio;
identifying an actual sound intensity weight ratio between a human voice audio and an accompaniment audio in the initial reverberation audio, and adjusting a sound intensity of the human voice audio and/or the accompaniment audio in the initial reverberation audio according to the actual sound intensity weight ratio to acquire a target reverberation audio; and
playing the target reverberation audio.

2. The sound field expansion method according to claim 1, wherein the adjusting the sound intensity of the human voice audio and/or the accompaniment audio in the initial reverberation audio according to the actual sound intensity weight ratio to acquire the target reverberation audio comprises:
acquiring a target sound intensity weight ratio between the human voice audio and the accompaniment audio; and
adjusting the sound intensity of the human voice audio and/or the accompaniment audio in the initial reverberation audio according to the actual sound intensity weight ratio and the target sound intensity weight ratio, such that the actual sound intensity weight ratio is adjusted to the target sound intensity weight ratio, to acquire the target reverberation audio.

3. The sound field expansion method according to claim 2, wherein the acquiring the target sound intensity weight ratio between the human voice audio and the accompaniment audio comprises:
identifying the initial reverberation audio by a converged neural network model to acquire an audio type corresponding to the initial reverberation audio; and
retrieving a sound intensity weight ratio to which the audio type maps from a preset mapping data table according to the audio type, wherein the sound intensity weight ratio to which the audio type maps is the target sound intensity weight ratio between the human voice audio and the accompaniment audio.

4. The sound field expansion method according to claim 2, wherein the adjusting the sound intensity of the human voice audio and/or the accompaniment audio in the initial reverberation audio comprises:
increasing a sound intensity of the human voice audio in the initial reverberation audio; and/or
reducing a sound intensity of the accompaniment audio in the initial reverberation audio.

5. The sound field expansion method according to claim 1, wherein the acquiring the target transfer function between the near-ear open audio device and the ears of the user comprises:
acquiring a preset artificial head transfer function and a free-field transfer function;
performing an inverse operation on the free-field transfer function to acquire a free-field inverse transfer function; and
multiplying the artificial head transfer function by the free-field inverse transfer function, to acquire the target transfer function between the near-ear open audio device and the ears of the user.

6. The sound field expansion method according to claim 5, wherein the acquiring the preset artificial head transfer function and the free-field transfer function comprises:
when the near-ear open audio device is worn on a preset artificial head and the near-ear open audio device outputs a sound signal, measuring the artificial head transfer function by preset microphones in ear canals of the artificial head; and
when the artificial head is removed and the near-ear open audio device outputs a sound signal, measuring a free-field transfer function by preset microphones placed at positions of left and right ears before the artificial head is removed.

7. The sound field expansion method according to claim 1, wherein the performing the crosstalk elimination processing on the input audio received by the near-ear open audio device according to the target transfer function to acquire the initial reverberation audio comprises:
performing an inverse operation on the target transfer function to acquire a target inverse transfer function; and
multiplying the input audio received by the near-ear open audio device by the target inverse transfer function to acquire the initial reverberation audio.

8. The sound field expansion method according to claim 2, wherein the identifying the actual sound intensity weight ratio between the human voice audio and the accompaniment audio in the initial reverberation audio comprises:
dividing the initial reverberation audio into a plurality of frames, wherein each frame of the initial reverberation audio has an accompaniment audio and a human voice audio in a time-synchronized relationship;
performing a windowing processing on each frame of the initial reverberation audio, and transforming the initial reverberation audio after the windowing processing from a time domain to a frequency domain by a fast Fourier transform, to acquire an initial reverberation spectrum;
separating the initial reverberation spectrum to acquire an accompaniment spectrum and a human voice spectrum in the initial reverberation spectrum; and
determining the actual sound intensity weight ratio between the human voice audio and the accompaniment audio in the initial reverberation spectrum according to the accompaniment spectrum and the human voice spectrum,
wherein the adjusting the sound intensity of the human voice audio and/or the accompaniment audio in the initial reverberation audio according to the actual sound intensity weight ratio and the target sound intensity weight ratio to acquire the target reverberation audio comprises:
performing a sound intensity increasing process on the human voice spectrum in the initial reverberation spectrum and/or performing a sound intensity decreasing process on the accompaniment spectrum in the initial reverberation audio according to the actual sound intensity weight ratio and the target sound intensity weight ratio, to acquire a target reverberation spectrum; and
transforming the target reverberation spectrum from the frequency domain to the time domain, to acquire the target reverberation audio.

9. An audio device comprising: a memory, a processor, and a sound field expansion program stored in the memory and executable by the processor, wherein the sound field expansion program, when executed by the processor, implements steps of the sound field expansion method according to claim 1.

10. A non-transitory computer-readable storage medium, wherein a sound field expansion program is stored on the computer-readable storage medium, and when the sound field expansion program is executed by a processor, steps of the sound field expansion method according to claim 1 are implemented.
